(19) United States
(12) Patent Application Publication
(10) Pub. No.: US 2016/0280203 A1
(43) Pub. Date: Sep. 29, 2016

(54) CONTROLLING SYSTEM FOR HYBRID ELECTRIC VEHICLE AND CONTROLLING METHOD THEREOF

(71) Applicant: SAMSUNG ELECTRO-MECHANICS CO., LTD., Suwon-Si (KR)

(72) Inventors: Hyun Jik YANG, Suwon-Si (KR); Geun Hong LEE, Suwon-Si (KR)

(73) Assignee: SAMSUNG ELECTRO-MECHANICS CO., LTD., Suwon-Si (KR)

(21) Appl. No.: 14/946,153

(22) Filed: Nov. 19, 2015

(30) Foreign Application Priority Data
Mar. 24, 2015 (KR) 10-2015-0040784

(51) Int. Cl. B60W 20/10; B60W 30/18; B60W 10/08; B60W 20/13; B60W 10/06

(52) U.S. Cl. CPC B60W 20/10; B60W 20/13; B60W 10/06; B60W 10/08; B60W 30/181; B60W 2550/20; B60W 2510/244; B60W 2710/08; B60W 2710/06; Y10S 903/93

(57) ABSTRACT

A controlling system for a hybrid vehicle, the controlling system including an engine configured to stop running when the vehicle stops; a motor configured to provide a driving power to the vehicle, wherein the motor is supplied with electric power through a battery; a traffic information receiver configured to receive traffic information; and a processor configured to control the engine or the motor, or both, based on the traffic information.

### CROSS-REFERENCE TO RELATED APPLICATION(S)

This application claims the benefit of Korean Patent Application No. 10-2015-0040784, filed on Mar. 24, 2015, in the Korean Intellectual Property Office, the entire disclosure of which is incorporated herein by reference for all purposes.

### BACKGROUND

1. Field

This application relates to a controlling system for a hybrid electric vehicle and a controlling method thereof.

2. Description of Related Art

A hybrid electric vehicle represents a vehicle driven by using two power sources and is called a hybrid electric vehicle (hereinafter, referred to as a ‘vehicle’) and is configured in such a manner that power sources having different characteristics inter-complementarily operate to improve efficiency and primarily adopts a scheme using both the existing internal combustion engine and an electric motor.

In a driving zone in which efficiency of an engine is relatively decreased, the power of the engine is complemented by using the electric motor or in a low-speed driving section in which characteristics of the electric motor are excellent, the vehicle is driven by using only the output of the motor without operation of the engine to improve total fuel efficiency of the vehicle.

As an example, a system for controlling power of a current green car and a current electric vehicle relates to a hybrid electric vehicle (hereinafter, referred to as a vehicle) including a first battery (48 V), a second battery (12 V), an inverter, a converter (DC_DC converter), and a motor has a bidirectional function including a function to raise 12 V to 48 V and a function to drop 48 V to 12 V.

Other features and aspects will be apparent from the following detailed description and drawings.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a controlling system for a hybrid electric vehicle and a controlling method thereof includes: an engine configured to stop running when the vehicle stops; a motor, wherein the motor provides a power assistance, or driving power, to the vehicle, wherein the motor is supplied with electric power through a first battery; a traffic information receiver configured to receive traffic information; and a processor configured to control the engine or a power assistance amount from the motor, or any combination thereof, based on the traffic information.

The controlling method and system for the hybrid electric vehicle may further include controlling a hybrid electric vehicle based on traffic information, and a processor controlling the operation of the engine and the amount of power assistance, or driving power, from an electric motor increases when a distance from the vehicle to a signal lamp, or traffic signal, is larger than a predetermined first set value for a traffic congested section. The controlling method and system for the hybrid electric vehicle increases the amount of power assistance from the electric motor to increase when the length of a deceleration section is larger than a predetermined second set value to thereby enhance fuel efficiency of the hybrid electric vehicle.

According to another general aspect, a method of controlling a hybrid electric vehicle system, the controlling method includes determining whether a vehicle is in a stop section or a deceleration section, or any combination thereof, based on traffic information; predicting a first fuel consumption, consumed due to restarting an engine after running of the engine stops when the vehicle enters the stop section, and a second fuel consumption, consumed due to running the engine during the stop section, in order to control the engine and a motor; and predicting a charge amount of a battery, which is charged during the deceleration section when the vehicle enters the deceleration section, and a power consumption of the battery, which is consumed due to an increase in the amount of driving power from the motor, to control the motor.

### BRIEF DESCRIPTION OF DRAWINGS

FIG. 1 is a block diagram illustrating an example of a controlling system for a hybrid electric vehicle;

FIG. 2 is a graph illustrating an example of a change amount of an SOC shown by decreasing the lower limit threshold of the SOC of a first battery; and

FIG. 3 is a flowchart illustrating an example of a controlling method for a hybrid electric vehicle.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms.

Hereinafter, a power assistance amount of a motor 400 means an amount of driving power which is provided by the motor 400 for driving a vehicle.

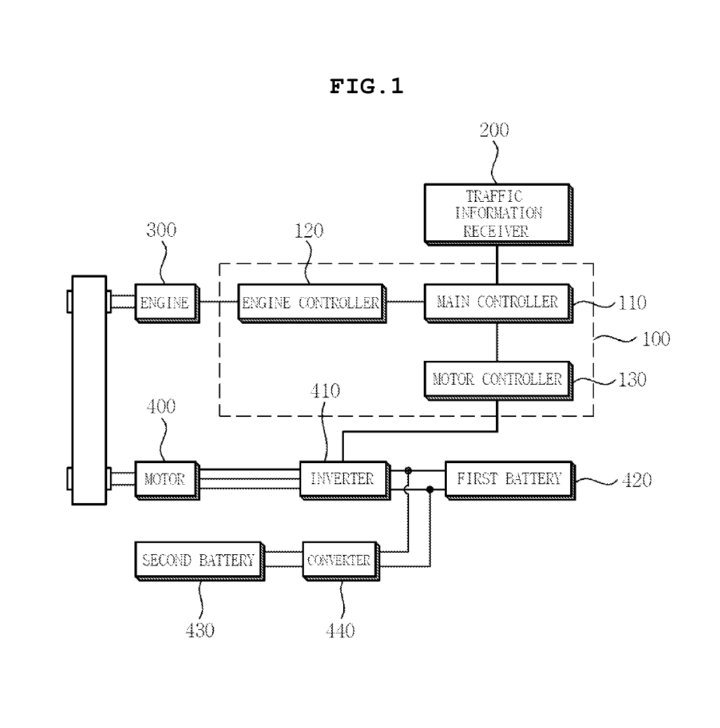

FIG. 1 is a block diagram illustrating a controlling system for a hybrid electric vehicle. As illustrated in FIG. 1, the block diagram includes first and second batteries 420 and 430, an inverter 410, a converter 440, an engine 300, a motor 400, a processor 100, and a traffic information receiver 200.

The engine 300 generates power for driving the vehicle and performs an idle stop and go (ISG) function in which the engine turns off when the vehicle stops. The ISG function improves fuel efficiency and a system in which running of the engine 300 stops automatically after several seconds after the vehicle stops (for example, when a brake pedal is pressed and a vehicle speed signal is 0 for about three seconds, the engine 300 turns off). Restarting is automatically performed without operating an ignition key when a driver's intention is detected (for example, the brake pedal is released or gear shifting is performed).

The motor 400 generates a rotation force by using electric energy to assist the power required for driving the vehicle. In detail, the motor 400 is be driven in an electric mode and a generation mode (a regenerative braking mode) according to a vehicle speed and efficiency of the engine 300. In a driving area (for example, a congested section, a deceleration section, or the like) where the efficiency of the vehicle engine 300 deteriorates, the power assistance amount of the motor 400 is increased without driving the engine 300 or the vehicle may be driven using only an output of the motor 400. Herein, the motor 400 may be an AC motor or a DC motor which is an electric motor 400, but is not limited thereto.

The first battery 420 and the second battery 430 are charged and discharged with constant voltage according to an operation mode (the electric mode or the generation mode) of the motor 400. The first battery 420 supplies power to the motor 400 through the inverter 410 or is charged through regenerative braking, and the second battery 430 supplies the power to components of a vehicle including a speaker, engine, lights and other vehicle components. For example, the first battery 420 may be a lithium battery, and voltages of the first battery 420 and the second battery 430 may be 48 V and 12 V, respectively.

Here, the regenerative braking means that the motor 400 operates as an electric generator to convert kinetic energy into electric energy. When the vehicle is decelerated by depressing the brake, inertial energy is captured by the motor and converted into electric energy through the motor 400 and the converted electric energy is stored in the first battery 420.

The inverter 410 is connected between the motor 400 and the first battery 420 in series. When the operation mode of the motor 400 is in the electric mode, the voltage applied from the first battery 420 is converted into an alternating current (AC) and transferred to the motor 400. In the generation mode (the regenerative braking mode), the voltage applied from the motor 400 is converted to a direct current (DC) to be transferred to the first battery 420. If the motor 400 is a DC motor an inverter may not be required.

The converter 440 is connected between the second battery 430 and the first battery 420 in parallel and may operate in a boosting mode or a bucking mode according to the operation mode of the motor 400. That is, the converter 440 may be a bidirectional DC-DC converter 440 which is driven in a boosting mode in which power is supplied to the motor 400 by boosting the voltage of the second battery 430 or a bucking mode in which the power is supplied to the second battery 430 by bucking the voltage supplied from the motor 400.

The traffic information receiver 200 receives traffic information in real time to transmit the received traffic information to the processor 100. The traffic information includes information (a location of a traffic signal, reduced speed limit section, a length of a speed bump section, a length of a downhill section, and other road characteristics) about a road based on a current location or route of the vehicle and information on a traffic volume (a congested section and a traffic flow). The traffic information receiver 200 may be, for example, a navigation system configured to receive a GPS signal or a smart phone configured to run a navigation application, and is not limited thereto. Further, the traffic information receiver 200 transmits traffic information through a communication module or a wired line to the processor 100 and the communication module through Bluetooth, Zigbee, or other wireless signal.

The processor 100 is connected to the traffic information receiver 200, the engine 300, the inverter 410, and controls whether to drive the engine 300 or the power assistance amount of the motor 400 based on the traffic information received through the traffic information receiver 200.

In detail, when describing the processor 100, the processor 100 receives the traffic information to determine the stop section of the vehicle. Here, the stop section means a section when the vehicle stops due a traffic condition comprising a traffic signal or entering a traffic congested section. When the vehicle enters the stop section, the ISG function operates to stop the engine 300 from running. In this case, the processor 100 compares a first fuel consumption, which is determined based on restarting of the engine after the running of the engine stops, with a second fuel consumption, which is determined based on maintaining the running of the engine 300 during the stop section to control the running of the engine 300 and the power assistance amount of the motor 400.

When the first fuel consumption, which is determined by the stopping and restarting of the engine 300, is larger than the second fuel consumption, which is determined by maintaining the running of the engine 300, the processor 100 increases the power assistance amount of the motor 400 while maintaining the running of the engine 300. On the contrary, when the first fuel consumption is smaller than the second fuel consumption, the processor 100 maintains the power assistance amount of the motor 400 or reduces the power assistance amount while turning off the engine 300.

The processor 100 controls the engine 300 and increase the power assistance amount of the motor 400 when a distance to the traffic signal is larger than a predetermined first set value in the traffic congested section in order to indirectly compare and predict the fuel consumption in the stop section. For example, when the vehicle enters the traffic congested section, the processor 100 recognizes whether the vehicle has entered the traffic congested section through the traffic information receiver 200 and determines the distance to the next traffic signal based on a current location of the vehicle. When the distance to the traffic signal is greater than the distance of the first set value, the processor 100 determines that the first fuel consumption is larger than maintaining the running of the engine 300 and increases the power assistance amount of the motor 400.

Here, the first set value is set by considering the specifications of the vehicle. That is, the first set value is set by considering an amount of fuel consumed in starting of the engine 300, an amount of fuel required for maintaining the running of the engine 300, the severity of the traffic congestion, and an average number of stopped vehicles and waiting time at a traffic signal. However, the first set value is not necessarily limited thereto and may be changed by the user.

The processor 100 determines the deceleration section based on the traffic information and controls the motor 400 to increase the power assistance amount when it determines that a predicted charging amount (i.e. amount the SOC increases due to charging) of the first battery 420 charged through the regenerative braking in the deceleration section is larger than a power consumption of the first battery 420 consumed due to the increase of the power assistance amount of the motor 400. In other words, the processor 100 predicts the amount the SOC will be increased due to charging through regenerative braking during deceleration section and increases the power assistance of the motor 400 if the predicted charging amount is greater than the power consumption of a predicted power assistance.

When the vehicle enters the deceleration section, generally, braking is performed by depressing the brake and thus it is easy to place the motor 400 into regenerative braking mode. Accordingly, the amount of charging of the first battery 420 through the regenerative braking can be increased, and as a result, even though the power assistance amount of the motor 400 is increased, the possibility of completely discharging of the first battery 420 is decreased. Therefore, it is possible to improve fuel efficiency required for driving of the vehicle by increasing the power assistance amount of the motor 400 when the vehicle enters the deceleration section.

The traffic information receiver 200 transmits information on the deceleration section to the processor 100 when the vehicle enters the deceleration section such as the speed bump section, the reduced speed section, the congested section, and the downhill section. In addition, the processor 100 controls the motor 400 by increasing the power assistance amount when the speed bump section, the reduced speed section, the congested section, and the downhill section are larger than a predetermined second set value.

For example, when the vehicle enters the speed bump section, the processor 100 determines that the vehicle enters a deceleration section through the traffic information receiver 200 and compares a length of the speed bump section with the second set value. When the length of the speed bump section is larger than the second set value, the processor 100 increases the power assistance amount of the motor 400.

Further, when many vehicles are congested and the traffic signal is located in the speed bump section, the processor 100 compares the first set value and the second set value with the distance to the traffic signal and the length of the speed bump section, respectively, and determines the power assistance amount of the motor 400 and whether to maintain running the engine 300. That is, when the vehicle exists the speed bump section and the distance to the traffic signal is far (that is, the first fuel consumption is larger than the second fuel consumption), the power assistance amount of the motor 400 is increased while the running of the engine 300 is maintained. Further, when the vehicle moves within the speed bump section and the distance to the traffic signal is closer, the running of the engine 300 stops when the vehicle stops and the increased power assistance amount of the motor 400 is maintained. In other words, the vehicle enters the stop section while in the deceleration section.

The processor 100 can decrease the lower limit threshold of the SOC of the first battery 420 and increase a ratio of torque from the motor in order to increase the power assistance amount of the motor 400. Further, as another method of increasing the power assistance of the motor 400, the processor 100 decreases the lower limit threshold of the SOC and increases an allowable speed of the vehicle at which the motor 400 provides power assistance.

The SOC is a criterion which represents the charge amount of the battery. The processor 100 determines SOC information of the first battery 420 by monitoring the voltage of the first battery 420. As an example, the processor 100 determines the SOC information of the first battery 420 by using a battery management system (BMS).

The SOC lower limit threshold means a lower limit value in an allowable range of the battery use amount. The battery is continuously charged and discharged, and when the battery is completely discharged (when the SOC is 0%), a phenomenon in which performance and durability of battery deterioration occurs. Accordingly, in order to prevent deterioration, the battery is used by setting the allowable range of SOC at which the battery can be used. The allowable range of SOC for the first battery 420 use can be increased by decreasing the SOC lower limit threshold of the first battery 420, and as a result, the output of the motor 400 is increased. In addition, as a result, the power assistance amount of the motor 400 is increased.

The engine 300 is mainly used during high-speed driving of the vehicle and the motor 400 assists with powering the vehicle while the vehicle is at a low speed. Here, the allowable speed of the vehicle means a speed of the vehicle in which the motor 400 provides power assistance changing from high-speed driving to low-speed driving. Accordingly, when the allowable speed of the vehicle is increased, an area where the motor 400 provides power assist is increased, and as a result, the power assistance amount of the motor 400 is increased.

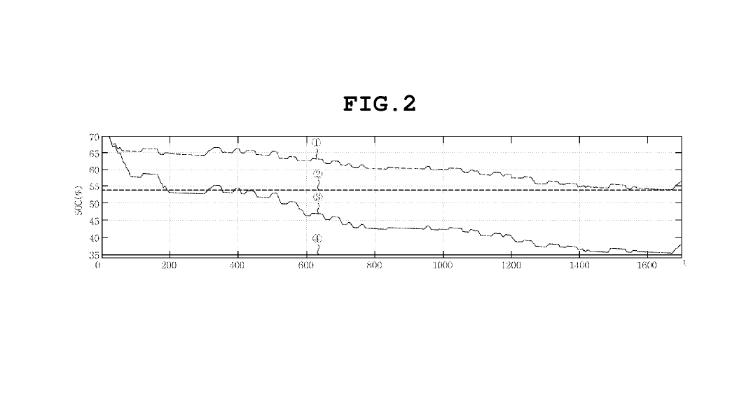

FIG. 2 illustrates a graph when the lower limit threshold of the SOC is decreased, and the following Table 1 is a table illustrating a change in fuel efficiency when the lower limit threshold of the SOC is decreased and the allowable speed of the vehicle is increased.

Line of \textcircled{1} FIG. 2 illustrates the SOC change amount of the first battery 420 in a normal mode, and line \textcircled{2} of FIG. 2 depicts the lower limit threshold of the SOC in the normal mode. Further, line \textcircled{3} of FIG. 2 illustrates the SOC change amount of the first battery 420 when the power assistance amount of the motor 400 is increased, and line \textcircled{4} of FIG. 2 illustrates the SOC lower limit threshold of the first battery 420 when the power assistance amount of the motor 400 is increased.

TABLE 1

| | | | Increase in | |
|---|---|---|---|---|
| | | | power assistance | |
| | Normal mode | | amount of motor 400 | |
| Lower limit threshold of SOC | 54% | | 35% | |
| Allowable speed | 18 | km/h | 25 | km/h |
| Fuel efficiency | 14.27 | km/l | 14.65 | km/l |

| | |
|---|---|
| Improvement of fuel efficiency | 2.7% |

Referring to FIG. 2 and Table 1, when the SOC lower limit threshold of the first battery 420 is decreased from 54% to 35% and simultaneously, the allowable speed of the vehicle is increased from 18 km/h to 25 km/h, it can be seen that the fuel efficiency of the vehicle is improved from 14.27 km/l to 14.65 km/l.

Further, the power assistance amount of the motor 400 can be increased by increasing a torque ratio of the motor 400. Here, the torque ratio means a ratio at which each of the engine 300 and the motor 400 provide the torque required to drive the vehicle, respectively, to the total torque provided to drive the vehicle (e.g. torque ratio of the motor 400 is the ratio of the torque provided by the motor 400 to the total torque provided by the engine 300 and motor 400). When the torque ratio of the motor 400 is increased, the power assistance amount of the motor 400 is increased together. Table 2 is a table representing a change amount of fuel efficiency when the torque ratio varies and the lower limit threshold of the SOC is decreased in order to increase the power assistance amount of the motor 400.

TABLE 2

| | | Increase in |
|---|---|---|
| | | power assistance |
| | Normal mode | amount of motor 400 |
| Lower limit threshold of SOC | 54% | 35% |
| Torque ratio of motor 400 | 40% | 60% |
| Fuel efficiency | 14.27 km/l | 14.57 km/l |

| | |
|---|---|
| Improvement of fuel efficiency | 2.1% |

Referring to FIG. 2 and Table 2, when the SOC lower limit threshold of the first battery 420 is decreased from 54% to 35% and simultaneously, the torque ratio of the motor 400 is increased from 40% to 60%, it can be seen that the fuel efficiency of the vehicle is improved from 14.27 km/l to 14.57 km/l.

In order to increase the power assistance amount of the motor 400, the allowable speed of the vehicle in which power assistance is provided may be increased while the lower limit threshold of the SOC is decreased. Further, in order to increase the power assistance amount of the motor 400, the torque ratio of the motor 400 is increased while the lower limit threshold of the SOC is decreased. However, it is not necessary to control the allowable speed and the torque ratio while decreasing the lower limit threshold of the SOC. The power assistance amount of the motor 400 may be increased by independently controlling the lower limit threshold of the SOC, the allowable speed, and the torque ratio, respectively, or the power assistance amount of the motor 400 may be increased by simultaneously controlling the lower limit threshold of the SOC, the allowable speed, and the torque ratio.

The processor 100 includes a main controller 110, an engine controller 120, and a motor controller 130 as illustrated in FIG. 1. The processor 100 is implemented by one circuit or semiconductor chip (for example, a semiconductor chip or an application-specific integrated circuit) in order to perform the above-described function or performed by including the main controller 110, the engine controller 120, and the motor controller 130 to be described below. Further, in order to implement an algorithm for performing the function, firmware or software, or a combination of both, is used.

The main controller 110 determines a stop section or a deceleration section based on the traffic information, generate a driving control signal of the engine 300 and a power assistance control signal of the motor 400 according to a predicted fuel consumption in the stop section, and generate a power assistance control signal of the motor 400 according to a predicted charging amount of the first battery 420 in the deceleration section.

That is, the main controller 110 generates the driving control signal of the engine 300 and the power assistance control signal of the motor 400 according to the distance to the traffic signal in the traffic congested section based on the traffic information and generates the power assistance control signal according to a length of the deceleration section. In this case, the main controller 110 compares the distance up to the traffic signal in the congested section with the aforementioned first set value and compares the length of the deceleration section with the aforementioned second set value, respectively, to predict the amount of fuel consumed in the stop section and the charging amount charged in the stop section.

The engine controller 120 controls whether the engine 300 is run according to the driving control signal of the engine 300, and particularly, controls to maintain the engine 300 in a running state according to the driving control signal generated by the main controller 110 when the distance to the traffic signal in the congested section is larger than the first set value.

The motor controller 130 controls the power assistance amount of the motor 400 according to the power assistance control signal and to this end, is embedded in the inverter 410. The motor controller 130 decreases the SOC lower limit threshold of the first battery 420 and increase the allowable speed of the vehicle at which the power assistance of the motor 400 is performed by the power assistance control signal of the motor 400. Further, the power assistance amount of the motor 400 is controlled by adjusting the torque ratio of the motor 400.

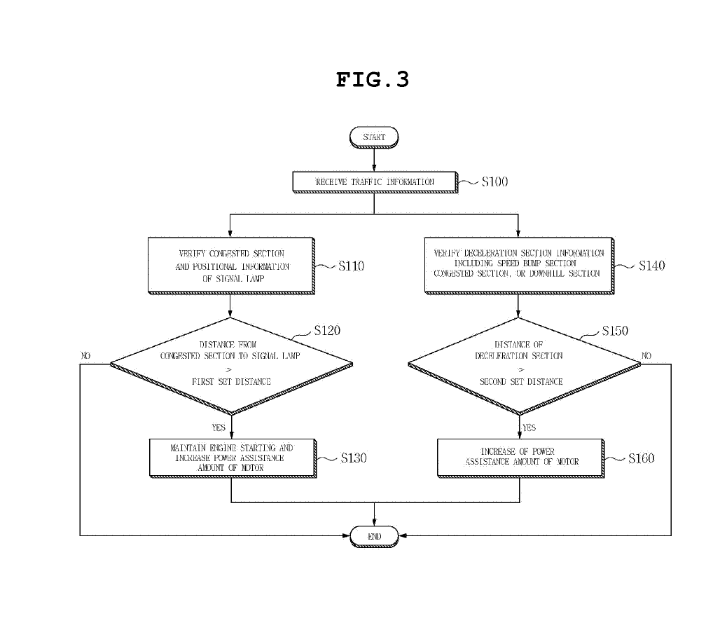

Hereinafter, a method of controlling a hybrid electric vehicle is described. The configuration described above will be described with reference to FIG. 3. In the following description, like reference numbers refer to like elements throughout the drawings, which illustrate various exemplary embodiments of the present disclosure.

As illustrated in FIG. 3, the controlling method of the hybrid electric vehicle system according to the present disclosure includes determining whether the vehicle enters a stop section or a deceleration section based on real-time traffic information, a stop section step of controlling whether the engine 300 is running and the power assistance amount of the motor 400 by predicting a first fuel consumption amount consumed by restarting after running of the engine 300 stops when the vehicle enters the stop section and a second fuel consumption consumed by maintaining the driving of the engine 300 during the stop section, and a deceleration section step of controlling the power assistance amount of the motor 400 by predicting a charging amount of the first battery 420 charged in the deceleration section when the vehicle enters the deceleration section and a power consumption of the first battery 400 consumed by increasing the power assistance amount of the motor 400. A detailed description of each step will be described below.

First, the traffic information is received through the traffic information receiver 200 (S100) and it is determined whether the vehicle enters the stop section or the deceleration section. Herein, the stop section means a section in which the vehicle stops due to traffic signal waiting in the congested section, and the deceleration section comprises a speed bump section, reduced speed section, a congested section, and a downhill section.

When the vehicle enters the stop section, the congested section and location information of the traffic signal are checked (S110). Next, comparing the distance to the traffic signal in the congested section with a predetermined first set value (S120) and maintaining the state of the engine 300 (i.e. running or not running) by determining that the first fuel consumption is larger than the second fuel consumption when the distance to the traffic signal in the congested section is larger than the first set value (S130) are performed.

Herein, the first set value is predetermined by a specification of a vehicle having a fuel amount which is the same as a fuel amount consumed by restarting and the distance up to the signal lamp and the first set value are compared with each other in order to indirectly compare and predict the first fuel consumption and the second fuel consumption.

In this case, the operation state of the engine 300 is maintained and the power assistance amount of the motor 400 is increased. To this end, the controlling method is performed by further including decreasing a lower limit threshold of an SOC of the first battery 420 and increasing an allowable speed of the vehicle in which power assistance of the motor 400 is achieved. Further, instead of increasing the allowable speed of the vehicle, the controlling method is performed by further including increasing the torque ratio for more power assistance from the motor 400. However, it is not necessary to increase the allowable speed or increase the torque ratio while decreasing the lower limit threshold of the SOC. Each may be performed independently to increase the power assistance amount of the motor 400 or the SOC lower limit threshold, the allowable speed, and the torque ratio may be controlled in parallel.

When the vehicle enters the deceleration section, the length (e.g., the length of the speed bump section, the length to the reduced speed section, the length of the downhill section, and the length of the congested section) of the deceleration section is verified (S140). Thereafter, a distance of the deceleration section and a predetermined second set value are compared with each other (S150). Then, when the distance of the deceleration section is larger than the second set value, it is determined that the charge amount is larger than power consumption and the power assistance amount of the motor 400 is increased (S160).

Herein, the second set value is set by efficiency of regenerative braking or a specification of the first battery 420 and the length of the deceleration section and the second set value are compared with each other in order to indirectly compare and predict the charge amount and the power consumption in the deceleration section.

When the length of the deceleration section is larger than the second set value, the lower limit threshold of the SOC of the first battery 420 is decreased and the allowable speed of the vehicle in which the power assistance of the motor 400 is provided is increased in order to increase the power assistance amount of the motor 400 as described above. Further, as another method for increasing the power assistance amount of the motor 400, the lower limit threshold of the SOC of the first battery 420 is decreased and the torque ratio provided by the power assistance of the motor 400 is increased.

As set forth above, the controlling system for the hybrid electric vehicle and the controlling method thereof control the running state of the engine 300 and the power assistance amount of the motor 400 based on the traffic information to enhance fuel efficiency of the hybrid electric vehicle.

The apparatuses, units, modules, devices, and other components illustrated in FIG. 1 that perform the operations described herein with respect to FIG. 1 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1 and 3. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIG. 3 that perform the operations described herein with respect to FIGS. * are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A controlling system for a hybrid vehicle, the controlling system comprising:
an engine configured to stop running when the vehicle stops;
a motor configured to provide a driving power to the vehicle, wherein the motor is supplied with electric power through a battery;
a traffic information receiver configured to receive traffic information; and
a processor configured to control the engine or the motor, or both, based on the traffic information.

2. The controlling system of claim 1, wherein the processor is configured to:
determine a stop section based on the traffic information,
predict a first fuel consumption based on restarting the engine after running of the engine stops in the stop section, and
predict a second fuel consumption based on maintaining the running of the engine during the stop section,
wherein the processor maintains a running of the engine and increases an amount of driving power from the motor when the first fuel consumption is greater than the second fuel consumption.

3. The controlling system of claim 2, wherein:
the traffic information receiver is configured to receive a congested section information and positional information of a traffic signal, and
the processor determines that the first fuel consumption is larger than the second fuel consumption, the processor maintains the running of the engine and increases the amount of driving power from the motor when a distance to the traffic signal is greater than a predetermined first set value in the congested section.

4. The controlling system of claim 3, wherein the processor decreases a lower limit threshold of a state of charge (SOC) of a battery voltage and increases a torque ratio to increase the amount of diving power from the motor.

5. The controlling system of claim 3, wherein the processor decreases the lower limit threshold of the state of charge (SOC) of a battery voltage and increases an allowable speed of the vehicle in which the motor provides driving power.

6. The controlling system of claim 1, wherein the processor is configured to:
determine a deceleration section based on the traffic information;
predict a charge amount of a battery during the deceleration section; and
predict a power consumption of the battery due to an increase in driving power from the motor, wherein the processor increases the amount of driving power from the motor if the charge amount is greater than the power consumption of the battery.

7. The controlling system of claim 6, wherein the traffic information receiver is configured to receive information on a speed bump section, a reduced speed section, a congested section, or a downhill section, or any combination thereof, and
the processor is configured to increase the amount of driving power from the motor when a distance of the speed bump section, the reduced speed section, the congested section, and the downhill section, or any combination thereof, is larger than a predetermined second set value, wherein the charge amount is larger than the power consumption of the battery.

8. The controlling system of claim 7, wherein the processor decreases the lower limit threshold of the state of charge (SOC) of a battery voltage and increases the torque ratio to increase the amount of driving power from the motor.

9. The controlling system of claim 7, wherein the processor is configured to decrease the lower limit threshold of the state of charge (SOC) of the battery voltage and increases the allowable speed of the vehicle in which the motor provides driving power to increase the amount of driving power from the motor.

10. The controlling system of claim 1, wherein:
the processor includes:
a main controller configured to:
generate a driving control signal for the engine and a driving power control signal for the motor according to a distance to a traffic signal in a congested section based on the traffic information, and generate the driving power control signal according to a length of a deceleration section;
an engine controller configured to control whether the engine is running according to the driving control signal; and
a motor controller configured to control the amount of driving power from the motor according to the driving power control signal.

11. A method of controlling a hybrid electric vehicle system, the controlling method comprising:
determining whether a vehicle is in a stop section or a deceleration section, or any combination thereof, based on traffic information;
predicting a first fuel consumption, consumed due to restarting an engine after running of the engine stops when the vehicle enters the stop section, and a second fuel consumption, consumed due to running the engine during the stop section, in order to control the engine and a motor; and
predicting a charge amount of a battery, which is charged during the deceleration section when the vehicle enters the deceleration section, and a power consumption of the battery, which is consumed due to an increase in the amount of driving power from the motor, to control the motor.

12. The method of controlling of claim 11,
further comprising:
comparing a distance to a traffic signal in a congested section and a predetermined first set value, and
maintaining a running state of the engine by determining that the first fuel consumption is larger than the second fuel consumption when the distance to the traffic signal is larger than the first set value in the congested section.

13. The method of controlling of claim 12, further comprising:
decreasing a lower limit threshold of an SOC of the battery in order to increase the power assistance amount from the motor; and
increasing an allowable speed of the vehicle in which the motor provides driving power.

14. The method of controlling of claim 12, further comprising:
decreasing the lower limit threshold of the SOC of the battery in order to increase the amount of driving power from the motor and increasing a torque ratio to increase the driving power from the motor.

15. The method of controlling of claim 11,
further comprising:
comparing a distance of the deceleration section with a predetermined second set value which, and
increasing the amount of driving power from the motor by determining that the charge amount is larger than the power consumption when the distance of the deceleration section is larger than the second set value.

16. The method of controlling of claim 15, further comprising:
decreasing the lower limit threshold of the SOC of the battery in order to increase the amount of driving power from the motor and increasing the allowable speed of the vehicle in which the motor provides driving power.

17. The method of controlling of claim 15, further comprising:
decreasing the lower limit threshold of the SOC of the battery in order to increase the power assistance amount of the motor and increasing a torque ratio to increase the driving power from the motor.
